(19) United States
(12) Patent Application Publication
(10) Pub. No.: US 2019/0368878 A1
(43) Pub. Date: Dec. 5, 2019

(54) METHOD FOR DETERMINING AN ORIENTATION OF A VEHICLE

(71) Applicant: Continental Teves AG & Co. oHG, Frankfurt am Main (DE)

(72) Inventors: Zhenfu Chen, Schwalbach (DE); Georg Roll, Frankfurt (DE)

(73) Assignee: Continental Teves AG & Co. oHG, Frankfurt am Main (DE)

(21) Appl. No.: 16/332,867

(22) PCT Filed: Aug. 22, 2017
(86) PCT No.: PCT/DE2017/200084

§ 371 Date: Mar. 13, 2019

(30) Foreign Application Priority Data
Oct. 6, 2016 (DE) 10 2016 219 379.1

(51) Int. Cl. G01C 21/16; G01C 22/02; B62D 15/02; G05D 1/02; G06F 17/13

(52) U.S. Cl. CPC G01C 21/165; G01C 22/025; G06F 17/13; G05D 1/0212; B62D 15/024

(57) ABSTRACT

The invention relates to a method for determining an orientation (ψ) of a vehicle relative to a spatially fixed coordinate system (x₀-0-y₀), the method comprising the following steps: determining a traveled distance (S,dS,ΔS) of at least one reference point (P) of the vehicle and/or at least one wheel of the vehicle, and calculating the orientation (Ψ) of the vehicle taking the traveled distance (S,dS,ΔS) into consideration. The invention further relates to a method based on this principle for determining a position (X_{P},Y_{P}) of a vehicle, to a method for determining an odometry of a vehicle, and to a corresponding control device of a vehicle.

### CROSS REFERENCE TO RELATED APPLICATIONS

This application is the U.S. National Phase Application of PCT International Application No. PCT/DE2017/200084, filed Aug. 22, 2017, which claims priority to German Patent Application No. 10 2016 219 379.1, filed Oct. 6, 2016, the contents of such applications being incorporated by reference herein.

### FIELD OF THE INVENTION

The present invention relates to a method for determining an orientation of a vehicle in relation to a spatially fixed coordinate system. The invention furthermore relates to a method, based on this principle, for determining a position of a vehicle, to a method for determining an odometry of a vehicle and to a corresponding control device for a vehicle.

### BACKGROUND OF THE INVENTION

For the automated driving of vehicles, automated parking (into or out of space) or driver assistance systems, it is important to be able to determine the current position and the course of the ego vehicle as accurately as possible. The change in the ego vehicle position with vehicle orientation over time is normally referred to as odometry. The quick and accurate determination of the odometry is of great importance for automated driving. The odometry is usually determined in two different ways. One way is by using hardware (e.g. super-accurate GPS devices or similar devices) to continually measure the vehicle position and vehicle orientation, which is very costly and sensitive to interference. The other way consists in calculating the vehicle position and vehicle orientation on the basis of the measurement quantities from the sensors present using a suitable mathematical model.

In the mathematical models, the vehicle velocities, accelerations and yaw velocity are typically used to determine the vehicle position and vehicle orientation.

The object of calculating the odometry is thus to determine the vehicle position and the vehicle orientation in a spatially fixed coordinate system at a given time t. The principles for this are illustrated below with the aid of FIG. 1. To describe the vehicle position, an arbitrary fixed point P in the vehicle can be used as a reference point, which reference point has the specific coordinates (X_{P},Y_{P}) in the spatially fixed coordinate system x₀-0-y₀ at a given time t=T. This reference point P may in principle be chosen arbitrarily. In FIG. 1, a point P on the longitudinal axis is chosen by way of example. The vehicle orientation is represented by the angle ψ of the vehicle longitudinal axis to the X₀-axis of the spatially fixed coordinate system, which angle is also referred to as the yaw angle. The odometry calculation should determine the current values for X_{P},Y_{P} and ψ during vehicle movement as quickly and as accurately as possible. A commonly used method consists in determining the two coordinates (X_{P},Y_{P}) and the angle ψ by integrating velocity components vₓ₀,v_{y0} and the yaw velocity \dot{ψ}.

The two velocity components vₓ₀,v_{y0} are derived from the velocity vector V_{P} with respect to the reference point P.

vₓ₀=V_{P} cos(β+ψ)

v_{y0}=V_{P} sin(β+ψ) (1)

where β is the angle between the velocity vector of the reference point P and the vehicle longitudinal axis or, in the vehicle coordinate system x-0-y, β is the angle of the velocity vector to the x-axis. The current coordinates are then derived as follows:

$${X}_{P} ( T ) = {\int }_{0}^{T} {V}_{P} cos ( β + ψ ) dt + {X}_{P} ( 0 ) \\ {Y}_{P} ( T ) = {\int }_{0}^{T} {V}_{P} sin ( β + ψ ) dt + {Y}_{P} ( 0 ) \qquad ( 2 )$$

The yaw angle ψ is calculated as follows:

$$ψ ( T ) = {\int }_{0}^{T} \dot{ψ} dt + ψ ( 0 ) \qquad ( 3 )$$

A disadvantage of this is that, in the case of slow driving, the measured yaw velocity \dot{ψ} is heavily affected by noise. As such, the yaw angle ψ calculated using equation (3) is too inaccurate for modern applications. The yaw angle ψ is again used in equation (2) to calculate the position of the vehicle in the spatially fixed coordinate system. Consequently, the position calculated on the basis of equation (2) is likewise too inaccurate. Because the odometry is calculated from the measurement quantities by integration over time, the error additionally builds up. As such, the calculated odometry can deviate substantially from the actual odometry. In particular for driving tasks involving low speeds or less driving dynamics, such mathematical models are not accurate enough.

### SUMMARY OF THE INVENTION

An aspect of the invention aims to provide a method by means of which a more accurate estimate of the position and/or orientation of a vehicle, in particular in the case of slow driving or with comparatively little transverse driving dynamics, can be made.

An aspect of the invention describes a method for determining an orientation of a vehicle in relation to a spatially fixed coordinate system, comprising the steps of:
determining a distance covered by at least one reference point of the vehicle and/or by at least one wheel of the vehicle; and
calculating the orientation of the vehicle on the basis of the covered distance.

An aspect of the invention is based on the concept not of integrating the vehicle orientation, and hence also position, in particular in the case of slow driving, using noisy signals, especially for the yaw velocity, over time, but rather of calculating them from reliable and accurate measurement quantities using a simple mathematical model. Here, it is not the time but rather the traveled distance that is used as the independent variable.

According to one preferred development of the method, in the case of a vehicle with front-wheel steering in particular, a midpoint between the wheels of the rear axle of the vehicle is used as the reference point. Advantageous simplifications that arise therefrom for the calculations result in the tangent to the distance being identical to the vehicle longitudinal axis.

The method preferably further comprises the steps of:
determining an angle between a tangent to the covered distance and a longitudinal axis of the vehicle or between a velocity vector of the vehicle and a vehicle longitudinal axis; and
calculating the orientation of the vehicle also on the basis of the angle.

The method preferably further comprises the steps of:
determining a course curvature and/or a course radius of the covered distance; and
calculating the orientation of the vehicle on the basis of the course curvature and/or of the course radius.

The orientation of the vehicle is preferably calculated using or on the basis of at least one of the following expressions:

$$d ψ = \frac{dS}{ρ} , d ψ = κ \cdot dS , d ψ \approx κ \cdot Δ S , \\ ψ ( S ) = {\int }_{0}^{S} κ ( s ) \cdot ds - ψ ( 0 ) .$$

Alternatively or in addition to this calculation of the orientation, the orientation of the vehicle can preferably be calculated using or on the basis of at least one of the following expressions:

$$d ψ = \frac{{dS}_{4} - {dS}_{3}}{{b}_{r}} , \\ d ψ \approx \frac{{dS}_{2} - {dS}_{1}}{{b}_{f}} cos {δ}_{A} ,$$

where b_{f} is a track width of the front axle, bᵣ is a track width of the rear axle, dS_{1 . . . 4} is a respective distance covered by a respective wheel of the vehicle and δ_{A} is a mean steering lock angle of the front wheels. This is particularly advantageous if the midpoint of the rear axle is used as the reference point, since it then therefore allows the differential or the change in the distance to be calculated both using the two wheel rotational speed sensors of the rear wheels and using the two wheel rotational speed sensors of the front wheels.

According to an aspect of the invention, for determining the covered distance, wheel ticks from at least one wheel rotational speed sensor assigned to at least one wheel of the vehicle are particularly preferably used.

According to one development of the invention, the distance covered by the midpoint of the rear axle of the vehicle is determined using or on the basis of at least the following expression:

$${dS}_{Cr} = \frac{{dS}_{3} + {dS}_{4}}{2} ,$$

where dS_{3,4} is a respective distance covered by a respective wheel of the rear axle of the vehicle.

Expediently, the angles between a tangent to the covered distance and a longitudinal axis of the vehicle or between a velocity vector of the vehicle and a vehicle longitudinal axis are determined on the basis of a steering wheel angle and/or of a mean steering lock angle of the front wheels and/or of a behavior of a steering system and of a travel direction signal.

Preferably, the angle between a tangent to the covered distance and a longitudinal axis of the vehicle or between a velocity vector of the vehicle and a vehicle longitudinal axis is determined using or on the basis of the following expression:

$$β = {δ}_{A} \approx \frac{{δ}_{SW}}{{i}_{L}} ,$$

where i_{L} is a steering ratio.

According to one development, the course curvature and/or the course radius of the covered distance are/is determined on the basis of a mean steering lock angle of the front wheels. In particular, the distance from the front axle to the rear axle may also be used as an alternative or in addition thereto.

An aspect of the invention furthermore relates to a method for determining a position of a vehicle in relation to a spatially fixed coordinate system, comprising the step of:
calculating the position of the vehicle on the basis of an orientation calculated by means of one embodiment of the method for determining an orientation of the vehicle according to an aspect of the invention.

Preferably, the method for determining a position of a vehicle further comprises the steps of:
determining an angle between a tangent to the covered distance and a longitudinal axis of the vehicle or between a velocity vector of the vehicle and a vehicle longitudinal axis; and
calculating the position of the vehicle also on the basis of the determined angle.

According to one advantageous embodiment of the method for determining a position of a vehicle, the position of the vehicle is calculated using or on the basis of at least one of the following expressions:

$$dX = cos ( ψ ( S ) + β ( S ) ) \cdot dS , dY = sin ( ψ ( S ) + β ( S ) ) \cdot dS , \\ X ( S ) = {\int }_{0}^{S} cos ( ψ ( s ) + β ( s ) ) \cdot ds , Y ( S ) = {\int }_{0}^{S} sin ( ψ ( s ) + β ( s ) ) \cdot ds ,$$

where X_{P}, Y_{P} are the coordinates of a reference point (P) of the vehicle in the spatially fixed coordinate system (x0-0-y0). This is particularly advantageous if the midpoint of the rear axle is used as the reference point, since in this case the angle β for the rear axle is always equal to 0 and it allows the coordinates of the midpoint of the rear axle to be calculated in a particularly straightforward manner.

An aspect of the invention furthermore relates to a method for determining an odometry of a vehicle, comprising the steps of:
determining an orientation of the vehicle in relation to a spatially fixed coordinate system by means of one embodiment of the method for determining an orientation of the vehicle according to an aspect of the invention; and
determining a position of a vehicle in relation to the spatially fixed coordinate system by means of one embodiment of the method for determining a position of the vehicle according to an aspect of the invention.

Here, the kinematic vehicle model preferably uses the number of wheel ticks from the wheel rotational speed sensors, the steering wheel angle or the behavior of the steering system and the travel direction signal. The measurement quantities, in particular steering wheel angle and wheel ticks, used are advantageously comparatively accurate and reliable. Accordingly, the odometries calculated in this way are likewise highly accurate and reliable as well as being straightforward, and hence quick, to calculate. A further advantage is that no additional hardware is needed.

An aspect of the invention furthermore relates to a control device for a vehicle, which control device is configured to carry out a method according to one of the preceding embodiments.

In one development of the specified control device, the specified device has a memory and a processor. In this case, the specified method is stored in the memory in the form of a computer program, and the processor is provided for carrying out the method when the computer program is loaded into the processor from the memory.

According to a further aspect of the invention, a computer program comprises program code means in order to perform all the steps of one of the specified methods when the computer program is executed on a computer or one of the specified apparatuses.

According to a further aspect of the invention, a computer program product contains a program code that is stored on a computer-readable data storage medium and that, when executed on a data processing device, performs one of the specified methods.

### BRIEF DESCRIPTION OF THE DRAWINGS

Some particularly advantageous configurations of aspects of the invention are specified in the subclaims. Further preferred embodiments also emerge from the following description of exemplary embodiments on the basis of figures.

In a schematic representation:

FIG. 1 shows a vehicle position (X_{P},Y_{P}) and vehicle orientation ψ in a spatially fixed system X₀,Y₀;

FIG. 2 shows vehicle parameters and movement quantities;

FIG. 3 shows a relationship between odometry and velocity vector;

FIG. 4 shows geometric relationships for a road vehicle with front-wheel steering for the purpose of explaining one exemplary embodiment of the method according to an aspect of the invention;

FIG. 5 shows geometric relationships for a road vehicle with all-wheel steering for the purpose of explaining one exemplary embodiment of the method according to an aspect of the invention; and

FIG. 6 shows geometric relationships for a road vehicle with limited transverse dynamics and slip angles for the purpose of explaining one exemplary embodiment of the method according to an aspect of the invention.

### DETAILED DESCRIPTION OF THE PREFERRED EMBODIMENTS

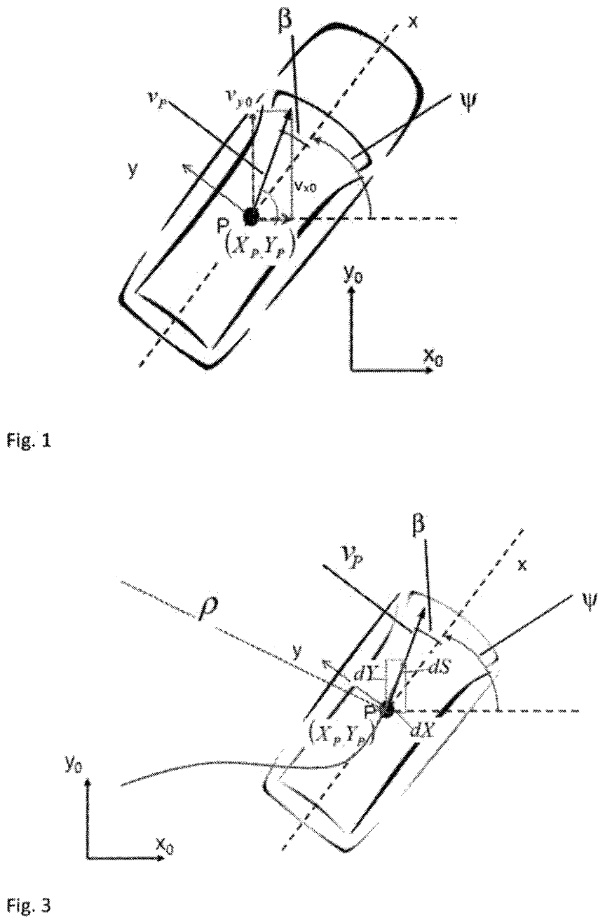

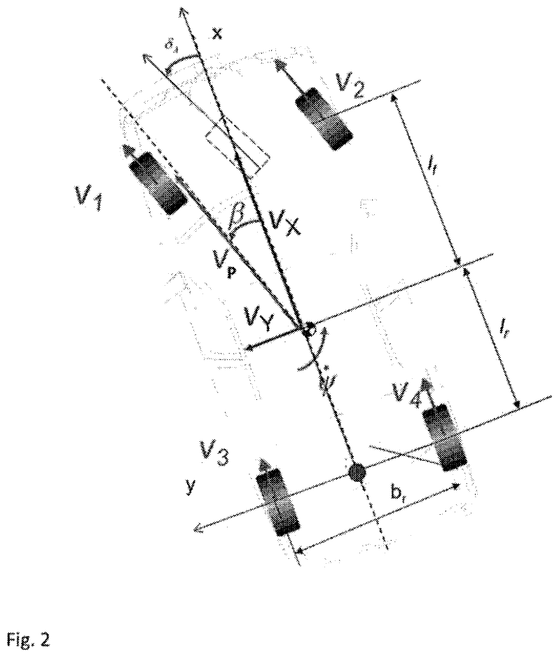

Based on the principles for calculating the odometry according to the prior art that have already been explained with the aid of FIG. 1, the method according to an aspect of the invention will be presented below with the aid of FIGS. 2 to 6, by means of which method the yaw angle ψ of the vehicle, in particular also in the case of slow driving, may be more accurately calculated.

For illustration, typical relevant parameters and movement quantities of a road vehicle are first shown in FIG. 2. Important parameters are for example:
the track width b_{f} of the front axle;
the track width bᵣ of the rear axle; and
the wheelbase l=l_{f}+lᵣ.

Important movement quantities are for example the four wheel velocities V₁, V₂, V₃ and V₄, the yaw velocity \dot{ψ} and the steering wheel angle δ_{SW}. These movement quantities may be measured and provided directly by the four wheel sensors, the angular rate sensor and the steering wheel sensor.

According to FIG. 3, at time t=T, the reference point P of the vehicle has the velocity vector V_{P} and drives along a course curve or odometry represented as a curved line up to reference point P with a course radius ρ or a course curvature κ:

$${V}_{P} = \frac{dS}{dt} = ( \dot{ψ} + \dot{β} ) \cdot ρ = \frac{( d ψ + d β )}{dt} \cdot ρ \qquad ( 4 )$$

where S is the length of the course curve or the distance covered by the reference point P at time t. The following relationship between the distance S and the yaw angle ψ of the vehicle in the case of driving with limited transverse dynamics

$$( \frac{d β}{dt} \approx 0 )$$

is obtained from equation (4):

$$d ψ = \frac{dS}{ρ} = κ \cdot dS \approx κ \cdot Δ S \qquad ( 5 )$$

In equation (5), the yaw angle is not dependent on the time t, but is a function of the distance S.

By calculating the integral according to equation (5) and with the distance S as the independent variable, the yaw angle ψ may be determined using the following equation:

$$ψ ( S ) = {\int }_{0}^{S} κ ( s ) \cdot ds - ψ ( 0 ) \qquad ( 6 )$$

To solve equation (6), the course curvature κ(S) as a function of the independent variable s and the covered distance S should preferably be known at any point in time.

Alternatively or in addition, in particular for vehicles with front-wheel steering, the yaw angle ψ may also be calculated by means of the relative movement of both wheels of the same axle:

$$\begin{matrix}d ψ = \frac{{dS}_{4} - {dS}_{3}}{{b}_{r}} \\ or & ( 7 ) \\ d ψ \approx \frac{{dS}_{2} - {dS}_{1}}{{b}_{f}} cos {δ}_{A} & ( 8 )\end{matrix}$$

The accuracy of the calculated yaw angle ψ according to equations (5), (6), (7) and (8) is mainly dependent on the resolution and the accuracy of the individual measured distances S₁ to S₄ of the four wheels, which are derived in particular from the respective wheel ticks from the wheel rotational speed sensors, as will be described in more detail further below. However, the vehicle parameters and the steering wheel angle also influence the accuracy of the calculated yaw angle ψ.

If the vehicle is modeled as a rigid body, all points on the vehicle have the same common yaw angle ψ. To solve it, an arbitrary point P on the vehicle may in principle be used, for which point the covered distance S as a function of time can be calculated and for which point the course curvature κ(s) and angle β(s) between the curve tangent and the vehicle longitudinal axis can be determined. Preferred exemplary embodiments for the calculation will be described further below in the description.

The coordinates (X_{P}, Y_{P}) of the reference point P are preferably likewise calculated as functions of the independent variable s using the following equations in differential form:

dX=cos(ψ(S)+β(S))·dS (9)

dY=sin(ψ(S)+β(s))·dS (10)

or in integral form

$$\begin{matrix}X ( S ) = {\int }_{0}^{S} cos ( ψ ( s ) + β ( s ) ) \cdot ds & ( 11 ) \\ Y ( S ) = {\int }_{0}^{S} sin ( ψ ( s ) + β ( s ) ) \cdot ds & ( 12 )\end{matrix}$$

For different reference points, different odometries and different distances S and different coordinates (X_{P}, Y_{P}) are obtained.

If, in equations (5), (9), and (10), a minus symbol is placed in front of the differential dS, the method according to an aspect of the invention may advantageously be used for the calculation in the case of the vehicle being driven in reverse.

Determining Angle β

To calculate equations (5), (6) and (9) to (12), the angle between the velocity vector V_{P} of the reference point P and the vehicle longitudinal axis or the change therein is used. This may be determined as follows according to one preferred embodiment.

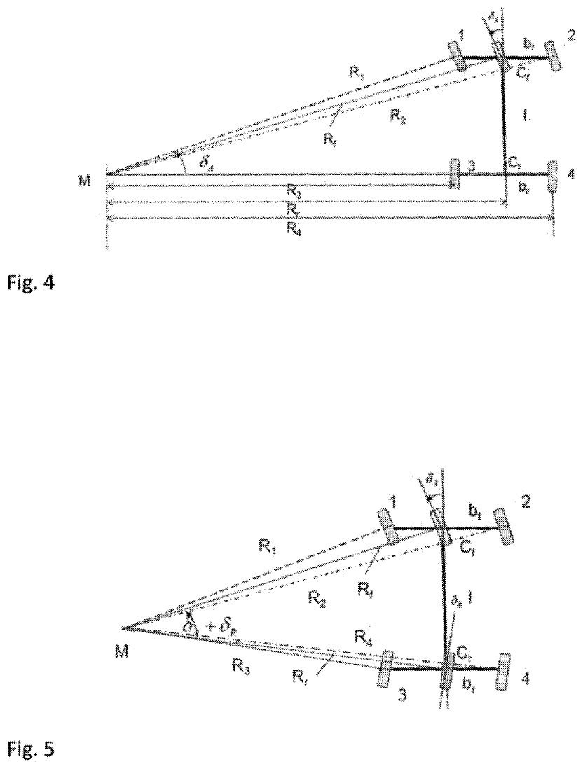

Only the front wheels are used for steering in a typical passenger motor vehicle, referred to as a vehicle with front-wheel steering. In the case of slow driving or limited transverse driving dynamics, the slip angles of the individual wheels may be disregarded. In this case, the geometric relationship shown in FIG. 4 is obtained. The mean steering lock angle δ_{A} of the front wheels, also known as the Ackermann angle, is a function of the steering wheel angle δ_{SW}, which may be measured relatively precisely by means of the steering wheel angle sensor and is present in most vehicles.

The separate steering lock angles δ₁ of wheel 1 and δ₂ of wheel 2 are likewise functions of the steering wheel angle δ_{SW} and are known. For wheel 3, wheel 4 and the midpoint Cᵣ of the rear axle, the velocity vector is always parallel to the vehicle longitudinal axis and hence the angle β is equal to 0. The velocity vector for wheel 1 and wheel 2 runs along the respective wheel planes, whereby the angle β is also known and is equal to the steering lock angle δ₁ for wheel 1 and to the steering lock angle δ₂ for wheel 2.

The relationship between the steering wheel angle δ_{SW} (not shown in FIG. 2) and the mean steering lock angle of the front wheels δ_{A} may be described approximately within a comparatively wide range by what is referred to as a steering ratio i_{L} using equation (13). For the midpoint C_{f} of the front axle, the velocity vector forms an angle δ_{A} with the vehicle longitudinal axis, whereby the angle β is always equal to the Ackermann angle δ_{A}:

$$β = {δ}_{A} = f ( {δ}_{SW} ) \approx \frac{{δ}_{SW}}{{i}_{L}} \qquad ( 13 )$$

Determining the Change in Distance dS or ΔS

To calculate equations (5) to (12), the differential dS or the change in distance S(t) within a short time period Δt is also used, which may be calculated as follows:

dS≈ΔS=S(t)−S(t−Δt) (14)

Here, the distances covered Sᵢ(t) by the individual wheels may be measured for most road vehicles using the, for example, four wheel rotational speed sensors, which deliver the current number of wheel ticks Zᵢ(t) as measurement results at all times. When free-rolling (driving without longitudinal slip), there is the following relationship between the covered distance Sᵢ(t) and the total wheel ticks Zᵢ(t):

S(t)=Bᵢ·Zᵢ(t) (15)

where 1=1, 2, 3, 4 is the index for the four different wheels and B is the difference in distance between two ticks and is typically constant for each wheel.

For wheels subject to longitudinal slip λ, the longitudinal slip λ may be estimated using a linear tire model and taken into account in equation (15) using a function Kᵢ(λ,t) according to equation (16):

ΔSᵢ(t)=Bᵢ·Kᵢ(λ,t)·ΔZᵢ(t) (16)

Kᵢ(λ,t) is equal to 1 for free-rolling wheels, smaller than 1 for driven wheels and greater than 1 for braked wheels. Because the longitudinal slip λ does not remain constant, the covered distances Sᵢ(t) must be divided into small steps, calculated for each step according to equation (17) and then summed:

Sᵢ(t)=ΣBᵢ·Kᵢ(λ,t)·ΔZᵢ(t) (17)

Using equation (15) or (17), the covered distances Sᵢ(t) for all of the wheels may be very accurately calculated. For the midpoint Cᵣ of the rear axle, the covered distance Sᵣ(t) may be derived from the two rear wheels:

$${S}_{r} ( t ) = \frac{{S}_{3} ( t ) + {S}_{4} ( t )}{2} \qquad ( 18 )$$

For the midpoint C_{f} of the front axle, the covered distance S_{f}(t) is determined from the two front wheels:

$${S}_{f} ( t ) = \frac{{S}_{1} ( t ) + {S}_{2} ( t )}{2} \qquad ( 19 )$$

Determining the Course Curvature κ(s)

As can be understood from FIG. 4, when the vehicle is driven in a curve, there is a center of rotation M and hence at least one imaginary right triangle MCᵣC_{f}, where the angle of the triangle at the center of rotation M, for the case of a vehicle with front-wheel steering as shown in FIG. 4, is equal to the Ackermann angle δ_{A}. If the midpoint Cᵣ of the rear axle is used as the reference point P, this then therefore gives, in a straightforward manner, the following course curvature:

$${κ}_{r} = \frac{1}{{R}_{r}} = \frac{tan {δ}_{A}}{l} \qquad ( 20 )$$

The midpoint C_{f} of the front axle has the following course curvature:

$${κ}_{f} = \frac{1}{{R}_{f}} = \frac{sin {δ}_{A}}{l} \qquad ( 21 )$$

The course curvatures for wheel 1 to wheel 4 are derived using the corresponding approach as follows:

$$\begin{matrix}{κ}_{1} = \frac{1}{{R}_{1}} = \frac{tan {δ}_{A}}{l \cdot \sqrt{{( 1 - \frac{{b}_{f} tan {δ}_{A}}{2 l} )}^{2} + {( tan {δ}_{A} )}^{2}}} & ( 22 ) \\ {κ}_{2} = \frac{1}{{R}_{2}} = \frac{tan {δ}_{A}}{l \cdot \sqrt{{( 1 + \frac{{b}_{f} tan {δ}_{A}}{2 l} )}^{2} + {( tan {δ}_{A} )}^{2}}} & ( 23 ) \\ {κ}_{3} = \frac{2 tan {δ}_{A}}{2 l - {b}_{r} tan {δ}_{A}} & ( 24 ) \\ and & \\ {κ}_{4} = \frac{2 tan {δ}_{A}}{2 l + {b}_{r} tan {δ}_{A}} & ( 25 )\end{matrix}$$

Consequently, all six of the points on the vehicle considered above may be used as reference points for calculating the yaw angle ψ or for calculating the odometries, as long as all four wheel sensors are operating without fault. It is however advantageous to use the midpoint Cᵣ of the rear axle as the reference point for calculating the odometry, since, on the one hand, the tangent for the odometry is always identical to the vehicle longitudinal axis and, on the other hand, the differential dS or the change in distance Sᵣ(t) may be calculated both using the two sensors of the rear wheels and using the two sensors of the front wheels:

$$\begin{matrix}dS \approx Δ S = {S}_{r} ( t ) - {S}_{r} ( t - Δ t ) = \frac{( {S}_{3} ( t ) - {S}_{3} ( t - Δ t ) ) + ( {S}_{4} ( t ) - {S}_{4} ( t - Δ t ) )}{2} & ( 26 ) \\ or & \\ dS \approx Δ S = {S}_{r} ( t ) - {S}_{r} ( t - Δ t ) = \frac{( {S}_{1} ( t ) - {S}_{1} ( t - Δ t ) ) + ( {S}_{2} ( t ) - {S}_{2} ( t - Δ t ) )}{2} cos {δ}_{A} & ( 27 )\end{matrix}$$

Because the angle β for the rear axle is always equal to 0, the coordinates of the midpoint Cᵣ of the rear axle may be calculated according to equations (11) and (12) in a particularly straightforward manner:

$${X}_{R} ( S ) = {{\int }^{S}}_{0} cos ( ψ ( s ) ) \cdot ds \\ {Y}_{R} ( S ) = {{\int }^{S}}_{0} sin ( ψ ( s ) ) \cdot ds \qquad ( 28 )$$

Especially in the case of parking (into or out of a space), situations arise in which the steering wheel is actuated while stationary and consequently the steering lock angle δ_{A} and, in the case of vehicles with all-wheel drive, also δ_{R}, changes greatly while stationary in a given position S=S_{B}. This means that the course curvature κ(s) in equations (5) and (6) changes abruptly when s=S_{B} and the function κ(s) of the distance s is not continuous when s=S_{B}. As such, the direction angle θ+ψ+β of the velocity vector of reference point P cannot be differentiated with respect to the independent variable s when s=S_{B}. Thus

$${\frac{d ( ψ + β )}{dS} \vert}_{S = {S}_{B}} = κ ( {S}_{B} )$$

does not exist. Therefore, when calculating the yaw angle ψ according to equation (6), in particular when the vehicle is stationary, this point is preferably bypassed with s=S_{B} and the integral for the yaw angle ψ with S>S_{B} is calculated in sections [0, SB−) and (SB+,S] as follows:

$$ψ ( S ) = {{\int }_{0}}^{{S}_{B -}} κ ( s ) \cdot ds + {{\int }^{S}}_{{S}_{B +}} κ ( s ) \cdot ds \qquad ( 29 )$$

It can be seen that the change in the steering wheel angle when stationary does not cause any sudden change in the yaw angle ψ and the yaw angle ψ remains continuous with respect to the independent variable s when S=S_{B}.

According to a further embodiment, the method according to an aspect of the invention may also be used for vehicles with all-wheel steering. For this, the course curvatures or course radii for the reference points are preferably calculated according to the geometric relationship shown in FIG. 5. Here, δ_{R} is the mean steering lock angle of the rear wheels and it normally has a defined relationship with the steering wheel angle δ_{SW}. Therefore, δ_{A} and δ_{R} are known. The six radii are dependent only on vehicle parameters b_{f}, bᵣ and l, and on the steering lock angles δ_{A} and δ_{R}.

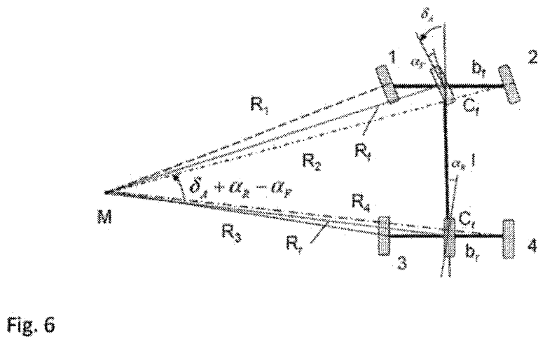

Although, in the case of a vehicle exhibiting limited transverse acceleration as illustrated in FIG. 6, the slip angles are not negligible, it is nonetheless still possible to calculate them relatively accurately using a linear tire model:

α_{F}=C_{F}·F_{YF}

α_{R}=C_{R}·F_{YR} (30)

Here, the slip angle is proportional to the lateral force, which may be determined from the measured vehicle transverse acceleration. The tire lateral stiffnesses C_{F} and C_{R} are vehicle parameters and generally constant. The method according to an aspect of the invention may also be used in such situations. Here, the slip angles α_{R} and α_{R} are expediently taken into account when calculating the course radii.

If it turns out in the course of the proceedings that a feature or a group of features is not absolutely necessary, then the applicant aspires right now to a wording for at least one independent claim that no longer has the feature or the group of features. This may be, by way of example, a subcombination of a claim present on the filing date or may be a subcombination of a claim present on the filing date that is limited by further features. Claims or combinations of features of this kind requiring rewording can be understood to be covered by the disclosure of this application as well.

It should further be pointed out that configurations, features and variants of aspects of the invention that are described in the various embodiments or exemplary embodiments and/or shown in the figures can be combined with one another in any way. Single or multiple features can be interchanged with one another in any way. Combinations of features arising therefrom can be understood to be covered by the disclosure of this application as well.

Back-references in dependent claims are not intended to be understood as dispensing with the attainment of independent substantive protection for the features of the back-referenced subclaims. These features can also be combined with other features in any way.

Features that are disclosed only in the description or features that are disclosed in the description or in a claim only in conjunction with other features may fundamentally be of independent significance essential to aspects of the invention. They can therefore also be individually included in claims for the purpose of distinction from the prior art.

### LIST OF REFERENCE SIGNS

x₀-0-y₀ spatially fixed coordinate system
x-0-y vehicle coordinate system
P reference point
X_{P},Y_{P} coordinates of the reference point P in the spatially fixed coordinate system
V_{P} velocity vector of reference point P
vₓ₀,v_{y0} velocity components of velocity vector V_{P}
Vᵢ velocity of wheel i
ψ vehicle orientation (angle of vehicle longitudinal axis to x₀-axis of spatially fixed coordinate system)
\dot{ψ} yaw velocity
β angle between velocity vector of reference point P and vehicle longitudinal axis
ρ course radius
κ course curvature
S length of course curve
b_{f} track width of front axle
bᵣ track width of rear axle
l_{f},lᵣ front axle/rear axle distance to reference point
l=l_{f}+lᵣ front axle-to-rear axle distance
C_{f} midpoint of front axle
Cᵣ midpoint of rear axle
M center of rotation of the vehicle
δ_{SW} steering wheel angle
δᵢ steering lock angle of wheel i
δ_{A} mean steering lock angle of front wheels
δ_{R} mean steering lock angle of rear wheels
i_{L} steering ratio
Zᵢ total wheel ticks from wheel i
Bᵢ difference in distance between two wheel ticks from wheel i
α_{F},α_{R} slip angle of front/rear axle wheels
C_{F},C_{R} tire lateral stiffnesses

1. A method for determining an orientation (ψ) of a vehicle in relation to a spatially fixed coordinate system (x₀-0-y₀), comprising:
determining a distance covered (S,dS,ΔS) by at least one reference point (P) of the vehicle and/or by at least one wheel of the vehicle; and
calculating the orientation (ψ) of the vehicle on the basis of the covered distance (S,dS,ΔS).

2. The method as claimed in claim 1, wherein, in the case of a vehicle with front-wheel steering in particular, a midpoint (Cᵣ) between the wheels of the rear axle of the vehicle is used as the reference point (P).

3. The method as claimed in claim 1, further comprising:
determining an angle (β) between a tangent to the covered distance (S,dS,ΔS) and a longitudinal axis (x) of the vehicle or between a velocity vector (V_{P}) of the vehicle and a vehicle longitudinal axis (x); and
calculating the orientation (ψ) of the vehicle also on the basis of the angle (β).

4. The method as claimed in claim 1, further comprising:
determining a course curvature (κ) and/or a course radius (ρ) of the covered distance (S,dS,ΔS); and
calculating the orientation (ψ) of the vehicle on the basis of the course curvature (κ) and/or of the course radius (ρ).

5. The method as claimed in claim 1, wherein the orientation (ψ) of the vehicle is determined using or on the basis of at least one of the following expressions:
$$d ψ = \frac{dS}{ρ} , d ψ = κ \cdot dS , d ψ \approx κ \cdot Δ S , \\ ψ ( S ) = {{\int }^{S}}_{0} κ ( s ) \cdot ds - ψ ( 0 ) .$$

6. The method as claimed in claim 1, wherein the orientation (ψ) of the vehicle is calculated using or on the basis of at least one of the following expressions:
$$d ψ = \frac{{dS}_{4} - {dS}_{3}}{{b}_{r}} , \\ d ψ \approx \frac{{dS}_{2} - {dS}_{1}}{{b}_{f}} cos {δ}_{A} ,$$
where b_{f} is a track width of the front axle, bᵣ is a track width of the rear axle, dS_{1 . . . 4} is a respective distance covered by a respective wheel of the vehicle and δ_{A} is a mean steering lock angle of the front wheels.

7. The method as claimed in claim 1, wherein, for determining the covered distance (S,dS,ΔS), wheel ticks from at least one wheel rotational speed sensor assigned to at least one wheel of the vehicle are used.

8. The method as claimed in claim 1, wherein the distance covered (S,dS,ΔS) by the midpoint (Cᵣ) of the rear axle of the vehicle is determined using or on the basis of at least the following expression:
$${dS}_{Cr} = \frac{{dS}_{3} + {dS}_{4}}{2} ,$$
where dS_{3,4} is a respective distance covered by a respective wheel of the rear axle of the vehicle.

9. The method as claimed in claim 3, wherein the angle (β) between a tangent to the covered distance (S,dS,ΔS) and a longitudinal axis (x) of the vehicle or between a velocity vector (V_{P}) of the vehicle and a vehicle longitudinal axis (x) is determined on the basis of a steering wheel angle (δ_{SW}) and/or of a mean steering lock angle of the front wheels (δ_{A}) and/or of a behavior of a steering system and of a travel direction signal.

10. The method as claimed in claim 3, wherein the angle (β) between a tangent to the covered distance (S,dS,ΔS) and a longitudinal axis (x) of the vehicle or between a velocity vector (VP) of the vehicle and a vehicle longitudinal axis (x) is determined using or on the basis of the following expression:
$$β = {δ}_{A} \approx \frac{{δ}_{SW}}{{i}_{L}} ,$$
where i_{L} is a steering ratio.

11. The method as claimed in claim 4, wherein the course curvature (κ) and/or the course radius (ρ) of the covered distance (S,dS,ΔS) are/is determined on the basis of a mean steering lock angle (δ_{A}) of the front wheels.

12. A method for determining a position (X_{P},Y_{P}) of a vehicle in relation to a spatially fixed coordinate system (x₀-0-y₀), comprising:
calculating the position (X_{P},Y_{P}) of the vehicle on the basis of an orientation (ψ) of the vehicle calculated by a method as claimed in claim 1.

13. The method as claimed in claim 12, further comprising:
determining an angle (β) between a tangent to the covered distance (S,dS,ΔS) and a longitudinal axis (x) of the vehicle or between a velocity vector (V_{P}) of the vehicle and a vehicle longitudinal axis (x); and
calculating the position (X_{P},Y_{P}) of the vehicle also on the basis of the determined angle (β).

14. The method as claimed in claim 12, wherein the position (X_{P},Y_{P}) of the vehicle is calculated using or on the basis of at least one of the following expressions:
$$dX = cos ( ψ ( S ) + β ( S ) ) \cdot dS , dY = sin ( ψ ( S ) + β ( S ) ) \cdot dS , X ( S ) = {{\int }^{S}}_{0} cos ( ψ ( s ) + β ( s ) ) \cdot ds , \\ Y ( S ) = {{\int }_{0}}^{S} sin ( ψ ( s ) + β ( s ) ) \cdot ds ,$$
where X_{P},Y_{P} are the coordinates of a reference point (P) of the vehicle in the spatially fixed coordinate system (x0-0-y0).

15. A method for determining an odometry of a vehicle, comprising:
determining an orientation (ψ) of the vehicle in relation to a spatially fixed coordinate system (x0-0-y0); and
determining a position (X_{P},Y_{P}) of a vehicle in relation to the spatially fixed coordinate system (x0-0-y0) as claimed in claim 12.

16. A control device for a vehicle comprising a memory and a processor, wherein the control device is configured to carry out at least one method as claimed in claim 1, wherein the method is stored in the memory in the form of a computer program and the processor is suitable for carrying out the method when the computer program is loaded into the processor from the memory.

17. The method as claimed in claim 2, further comprising:
determining an angle between a tangent to the covered distance and a longitudinal axis of the vehicle or between a velocity vector of the vehicle and a vehicle longitudinal axis; and
calculating the orientation of the vehicle also on the basis of the angle.

18. The method as claimed in claim 13, wherein the position (X_{P},Y_{P}) of the vehicle is calculated using or on the basis of at least one of the following expressions:
$$dX = cos ( ψ ( S ) + β ( S ) ) \cdot dS , dY = sin ( ψ ( S ) + β ( S ) ) \cdot dS , X ( S ) = {{\int }^{S}}_{0} cos ( ψ ( s ) + β ( s ) ) \cdot ds , \\ Y ( S ) = {{\int }_{0}}^{S} sin ( ψ ( s ) + β ( s ) ) \cdot ds ,$$
where X_{P},Y_{P} are the coordinates of a reference point (P) of the vehicle in the spatially fixed coordinate system (x0-0-y0).
